(19) United States
(12) Patent Application Publication
(10) Pub. No.: US 2025/0259355 A1
(43) Pub. Date: Aug. 14, 2025

(54) METHOD OF TRAINING IMAGE RESTORATION MODEL AND IMAGE RESTORATION APPARATUS FOR PERFORMING THE SAME

(71) Applicant: SEOUL NATIONAL UNIVERSITY R&DB FOUNDATION, Seoul (KR)

(72) Inventors: Se Young CHUN, Seoul (KR); Dongwon PARK, Seoul (KR); Ha Yeon KIM, Seoul (KR)

(21) Appl. No.: 18/943,628

(22) Filed: Nov. 11, 2024

(30) Foreign Application Priority Data
Feb. 13, 2024 (KR) 10-2024-0020268

(51) Int. Cl. G06T 11/60

(52) U.S. Cl. CPC G06T 11/60

(57) ABSTRACT

The embodiments disclosed herein are directed to a method of training an image restoration model and an image restoration apparatus for performing the same. According to an embodiment, the method is performed by an image restoration apparatus, and the method includes: pre-training an image restoration model by generating training images by randomly applying a plurality of synthetic degradation functions to a clean image; and fine-tuning parameters of the pre-trained image restoration model through contribution-based low-rank adaptation for an image restoration task; wherein fine-tuning the parameters includes fine-tuning parameters of each layer of the image restoration model based on the ratio of learnable network parameters, determined according to the contribution of each layer of the pre-trained image restoration model, and low-rank adaptation for the image restoration task.

### CROSS-REFERENCE TO RELATED APPLICATION

This application claims the benefit of Korean Patent Application No. 10-2024-0020268 filed on Feb. 13, 2024, which is hereby incorporated by reference herein in its entirety.

### BACKGROUND

### 1. Technical Field

The embodiments disclosed herein relate to a method of training an image restoration model that performs pre-training with random order degradation and fine-tunes parameters of an image restoration model, and an image restoration apparatus for performing the same.

The embodiments disclosed herein were derived as a result of the research on the task “Artificial Intelligence Graduate School Program (Seoul National University)” (task management number: IITP-2021-0-01343) of the Information, Communications and Broadcasting Innovative Talent Nurturing Project that was sponsored by the Korean Ministry of Science and ICT and the Institute of Information & Communications Technology Planning & Evaluation.

The embodiments disclosed herein were derived as a result of the research on the task “Deep-designed Medical Imaging Basic Research Laboratory” (task management number: NRF-2022R1A4A1030579) of the Group Research Support Project that was sponsored by the Korean Ministry of Science and ICT and the National Research Foundation of Korea.

The embodiments disclosed herein were derived as a result of the research on the task “Discovery of Novel Diagnostic and Therapeutic Technologies based on Extrachromosomal DNA” (task management number: NRF-2022M3C1A3092022) of the STEAM Research Project that was sponsored by the Korean Ministry of Science and ICT and the National Research Foundation of Korea.

### 2. Description of the Related Art

Image restoration (IR) is a basic low-level computer vision task that aims to restore input data, degraded by at least one of noise, blur and bad weather, to an original clean image.

Meanwhile, conventional image restoration methods require expensive training data for each type of image degradation. A model needs to be trained for each restoration task, as in Korean Patent Application Publication No. 10-2020-0084434. Recently, research is being conducted on a method for reducing costs and efficiently training a model by constructing a large-scale pre-trained model for cost reduction and efficient training.

In particular, for pre-training, it is important to learn various types of image degradation, and it is also important to tune parameters of a pre-trained model appropriately for the field of application. However, in order to efficiently use limited memory resources, there has arisen the need for a method of constructing training data that enables effective pre-training for various tasks and a technique for efficiently tuning parameters.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of an embodiment disclosed herein is to propose a method for training an image restoration model that may generate training data having undergone a random image degradation process, perform pre-training and fine-tune parameters of an image restoration model, and an image restoration apparatus that performs the same.

According to an aspect of the present invention, there is provided a method of training an image restoration model, the method being performed by an image restoration apparatus, the method including: pre-training an image restoration model by generating training images by randomly applying a plurality of synthetic degradation functions to a clean image; and fine-tuning parameters of the pre-trained image restoration model through contribution-based low-rank adaptation for an image restoration task; wherein fine-tuning the parameters includes fine-tuning parameters of each layer of the image restoration model based on the ratio of learnable network parameters, determined according to the contribution of each layer of the pre-trained image restoration model, and low-rank adaptation for the image restoration task.

According to another aspect of the present invention, there is provided an image restoration apparatus, including: memory configured to store an image restoration model and a program required for training the image restoration model; and a controller including at least one processor, and configured to train the image restoration model; wherein the controller pre-trains the image restoration model by generating training images by randomly applying a plurality of synthetic degradation functions to a clean image, and fine-tunes parameters of the pre-trained image restoration model for an image restoration task, in which case parameters of each layer of the image restoration model are fine-tuned based on low-rank adaptation according to a contribution for each layer of the pre-trained image restoration model for the image restoration task.

According to still another aspect of the present invention, there is provided a computer program that is executed by an image restoration apparatus and stored in a non-transitory computer-readable storage medium to perform a method of training an image restoration model, wherein the method includes: pre-training an image restoration model by generating training images by randomly applying a plurality of synthetic degradation functions to a clean image; and fine-tuning parameters of the pre-trained image restoration model through contribution-based low-rank adaptation for an image restoration task; and wherein fine-tuning the parameters includes fine-tuning parameters of each layer of the image restoration model based on the ratio of learnable network parameters, determined according to the contribution of each layer of the pre-trained image restoration model, and low-rank adaptation for the image restoration task.

According to still another aspect of the present invention, there is provided a non-transitory computer-readable storage medium having stored thereon a program that, when executed by a processor, causes the processor to execute a method of training an image restoration model, wherein the method includes: pre-training an image restoration model by generating training images by randomly applying a plurality of synthetic degradation functions to a clean image; and fine-tuning parameters of the pre-trained image restoration model through contribution-based low-rank adaptation for an image restoration task; and wherein fine-tuning the parameters includes fine-tuning parameters of each layer of the image restoration model based on the ratio of learnable network parameters, determined according to the contribution of each layer of the pre-trained image restoration model, and low-rank adaptation for the image restoration task.

According to some of the above-described solutions, obtaining training images by applying a plurality of synthetic degradation functions one by one in a random order may obtain a larger number of different types of training images than obtaining training images by applying a plurality of synthetic degradation functions in a fixed order or applying only one synthetic degradation function, so that a massive number of training images required for pre-training can be obtained, and thus, training can be performed for various degradations, thereby obtaining a single model capable of solving various restoration tasks.

Furthermore, according to some of the above-described solutions, fine tuning may be efficiently performed using only a number of parameters considerably smaller than the total number of parameters, so that memory load can be reduced and processing speed can be improved.

The advantages that can be achieved by the embodiments disclosed herein are not limited to the advantages described above, and other advantages not described above will be clearly understood by those having ordinary skill in the art, to which the embodiments disclosed herein pertain, from the foregoing description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating the configuration of an image restoration apparatus according to an embodiment;

FIG. 2 is a diagram illustrating a method of training an image restoration model according to an embodiment;

FIG. 3 is a diagram illustrating pre-training with random order degradation according to an embodiment;

FIG. 4 is a drawing illustrating the performance of pre-training with random order degradation according to an embodiment;

FIG. 5 is a diagram illustrating a method of fine-tuning network parameters according to a training method according to an embodiment;

FIG. 6 is a diagram illustrating the performance of contribution-based low-rank adaptation according to an embodiment; and

FIG. 7 is a flowchart illustrating a method of training an image restoration model according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

Prior to the following description, the meanings of the terms to be used herein are defined first.

The term “degradation” refers to a decrease in quality, and is also called “deterioration” or “worsening.” In the present specification, “degradation” and “deterioration” can be used interchangeably.

The “degraded image” refers to a low-quality image in which it is difficult to identify an object contained in the image due to noise, haze, raindrops, or the like, or an image which is generated based on a clean image but intentionally has lower quality than the original image.

A “clean image” is a high-quality image which allows an object included in the image to be easily identified, and refers to an image without degradation factors such as noise.

The term “image restoration” refers to the conversion of a low-quality image, in which it is difficult to identify an object included in the image due to noise, haze, raindrops, or the like, into a clean image.

The term “image restoration model” refers to an artificial intelligence model which restores a low-quality image, in which it is difficult to identify an object, included in the image, due to noise, haze, raindrops, or the like, into a clean image, and the image restoration model may be implemented as a neural network. For example, the image restoration model may be a transformer-based restormer or a convolutional neural network (CNN)-based nonlinear activation free network for image restoration (NAFNet), the restormer may include an encoder and a decoder, and the NAFNet can include an encoder, a decoder, and a middle layer between the encoder and the decoder. Furthermore, the encoder and decoder included in the restormer and the NAFNet and the middle layer included in the NAFNet may each include a plurality of layers.

Meanwhile, in the present specification, a layer may also be referred to as a block or network layer, and may include a plurality of parameters.

In the present specification, for the convenience of description, a neural network implementing an image restoration model may be described as an image restoration model or network, and both the image restoration model and network refer to a neural network implementing an image restoration model. Furthermore, in the present specification, unless otherwise stated, the network parameters and the parameters of the image restoration model both refer to the parameters included in the neural network implementing the image restoration model.

Embodiments will be described in detail below with reference to the accompanying drawings.

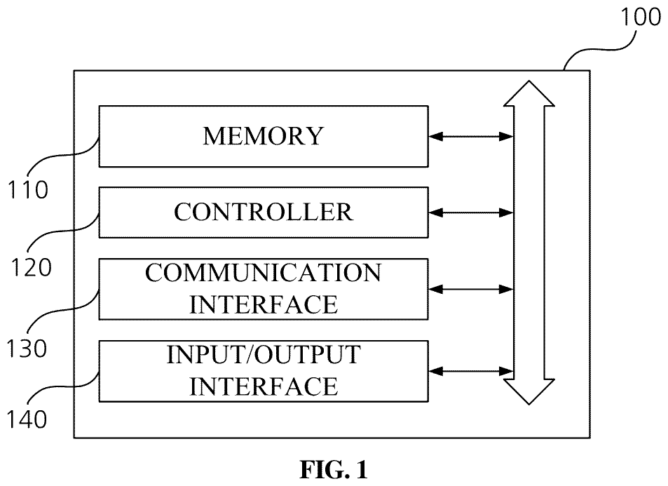

FIG. 1 is a block diagram illustrating the configuration of an image restoration apparatus according to an embodiment.

The image restoration apparatus 100 is an apparatus that restores a low-quality image to a clean image. The image restoration apparatus 100 may perform image restoration using the image restoration model described above. To this end, the image restoration apparatus 100 may generate training data, may pre-train the image restoration model based on the generated training data, and may fine-tune network parameters while performing re-training for an actual image restoration task.

The image restoration apparatus 100 may be implemented as an electronic terminal having an application installed therein, may be implemented as a server, or may be implemented as a server-client system. When the image restoration apparatus 100 is implemented as a server-client system, it may include an electronic terminal having a client for interaction with a user installed therein.

In this case, the electronic terminal may be implemented as a computer, a portable terminal, a television, a wearable device, etc. that may include an interface that allows interaction with a user. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like.

In addition, the server may be implemented as a computing device capable of communicating with the electronic terminal having a client for interaction with a user installed therein over a network, and may include a storage device capable of storing data or store data via a third-party server.

Referring to back to FIG. 1, the image restoration apparatus 100 according to an embodiment may include memory 110, a controller 120, and a communication interface 130.

The memory 110 may be constructed via various types of memory, and data and a program required for training may be installed and stored in the memory 110. For example, the memory 110 may store a program and data that enable the controller 120 to train the image restoration model according to a process to be presented below. For example, the memory 110 may store various synthetic degradation functions and an algorithm required to compute a FAIG score that is used to determine contribution.

The controller 120 is configured to include at least one processor such as a central process unit (CPU), a graphics processing unit (GPU), or the like, and may perform an image restoration method to be presented below by executing the program stored in the memory 110. A process in which the controller 120 performs an image restoration method according to an embodiment will be described in detail with reference to other drawings below.

The communication interface 130 may perform wired/wireless communication with another device or a network. For example, the communication interface 130 may receive data, required to train an image restoration model, from the other device or network.

To this end, the communication interface 130 may include a communication module configured to support at least one of various wired/wireless communication methods. The communication module may be implemented in the form of a chipset. The wireless communication supported by the communication interface 130 may be, for example, Wireless Fidelity (Wi-Fi), Wi-Fi Direct, Bluetooth, Ultra-Wide Band (UWB), or Near Field Communication (NFC).

According to an embodiment, the image restoration apparatus 100 may further include an input/output interface 140 configured to receive input from a user or to display information such as the results of image restoration or the results of the training of the image restoration model to the user. The input/output interface 140 may include various types of input devices (e.g., a keyboard, a touch screen, a camera, etc.) configured to receive input from a user, and may include an output device such as a display panel or a speaker.

A method of training an image restoration model according to an embodiment of the present invention, which is performed in such a manner that the controller 120 executes the program stored in the memory 110, will be described in detail below. The processes to be described below are performed in such a manner that the controller 120 executes the program stored in the memory 110, unless otherwise specifically stated.

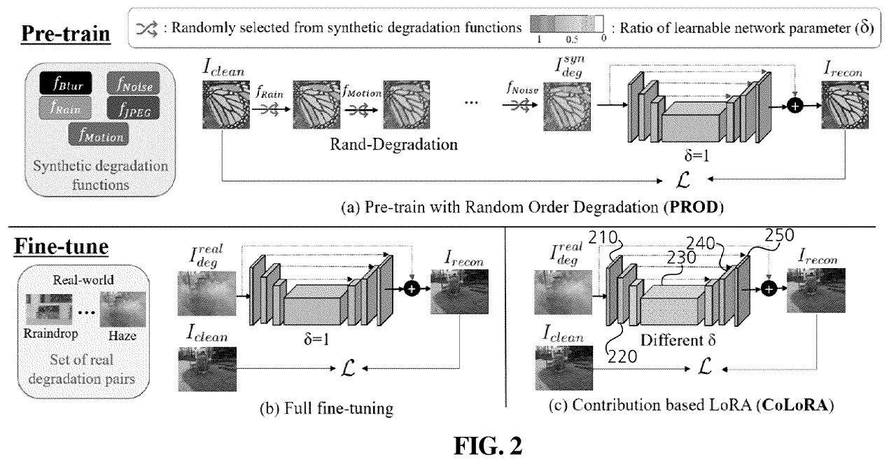

FIG. 2 is a diagram illustrating a method of training an image restoration model according to an embodiment.

Referring to FIG. 2, the method of training an image restoration model according to an embodiment includes pre-training with random order degradation (PROD) and contribution-based low-rank adaptation (CoLoRA). More specifically, the controller 120 may generate training images by degrading a clean image and applying a plurality of synthetic degradation functions in a random order, and may pre-train an image restoration model based on the generated training images.

Furthermore, the controller 120 may fine-tune some of the parameters of the pre-trained image restoration model while performing training for an actual image restoration task. More specifically, the controller 120 may update network parameters based on a loss function [symbol] derived from the difference between an output clean image I_{clean} and an original image by inputting low-quality training images I_{deg}^{real}, included in a dataset for an actual image restoration task, to the image restoration model.

In this case, the controller 120 does not perform full-fine training on all network parameters, as shown in the lower left of FIG. 2, but may determine the ratio of learnable network parameters for each layer according to the contribution of each layer included in a network according to contribution-based low-rank adaptation (CoLoRA) and update the parameters selected based on the determined ratio, as shown in the lower right of FIG. 2.

For example, referring to the bottom images of FIG. 2, in the case of full fine tuning on the left, the ratios of learnable network parameters δ of all layers are all 1. In contrast, in the case of contribution-based low-rank adaptation (CoLoRA) used in the training method according to an embodiment, the ratio of learnable network parameters δ of first blocks 210 and 250 on both ends is set to 1, the ratio of learnable network parameters δ of second blocks 220 and 240 on both ends is set to 0.05, and the ratio of learnable network parameters δ of a middle block 230 is set to 0.01, so that the ratios of learnable network parameters δ may be different from each other.

Pre-training with random order degradation (PROD) and contribution-based low-rank adaptation (CoLoRA) will be described in detail below.

Pre-Training with Random Order Degradation (PROD)

The controller 120 may generate synthetic degraded images I_{deg}^{syn}, i.e., low-quality training images, by selecting at least some of a plurality of different synthetic degradation functions ƒ_{Blur}, ƒ_{Noise}, ƒ_{Motion}, ƒ_{JPEG}, ƒ_{Rain} and applying the selected synthetic degradation functions to a clean image I_{clean} in a random order. The controller 120 may degrade a clean image using a plurality of synthetic degradation functions. For example, in a training method according to an embodiment, a total of seven types of synthetic degradation functions, including Gaussian noise, Poisson noise, Speckle noise, Gaussian blur, motion blur, JPEG compression, and rain, may be used. However, the present invention is not limited thereto, but the types and number of synthetic degradation functions may vary depending on the purpose of training.

For example, the synthetic Gaussian blur function may employ Gaussian kernels, generalized Gaussian kernels, and plateau-shaped kernels. The kernel size is randomly selected from the set of 7, 9, . . . , 21. For the generalized Gaussian kernels and the plateau-shaped kernels, shape parameters may be sampled in the intervals [0.5, 4] and [1, 2], respectively.

Furthermore, for example, the noise sigma range of the synthetic Gaussian noise function and the synthetic Poisson blur function may be set to [1, 30]. In particular, the Poisson noise scale may be set to [0.05, 3]. In addition, the quality factor of the synthetic JPEG compression function may be designated within the range of [30, 95].

Meanwhile, for example, the synthetic Gaussian blur function may employ central motion kernels (RIM et al), and the kernel size may be randomly selected from the set of 5, 7, 9, . . . , 31. For the synthetic rain function, the rain noise may be set to the range of [10, 1000], the rain length may be set to the range of [10, 90], the alpha value may be set to the range of [0.3, 1.3], and the rain angle may be set to the range of [−80, 80].

The controller 120 may generate low-quality training images by sequentially applying a plurality of different synthetic degradation functions to a clean image one by one and thus degrading the clean image. In this case, the controller 120 may achieve the synergic effect of both random single degradation and deterministic multiple degradations by randomly selecting and applying single synthetic degradation functions rather than applying a plurality of synthetic degradation functions one by one according to a fixed order.

Even when the same group of synthetic degradation functions are applied to a single clean image, generated training images may vary depending on the order in which the synthetic degradation functions are applied. More specifically, when N synthetic degradation functions selected from K different synthetic degradation functions are sequentially applied one by one and the order of application is randomly determined, a total of (K^{N+1}−1)/(K−1) different training images may be obtained.

For example, when K is 7 and N is 6, 137,000 different types of training images may be obtained. This is 4000 times larger than that in the case where only a single synthesis function is applied or the case where synthesis degradation is applied in a fixed order.

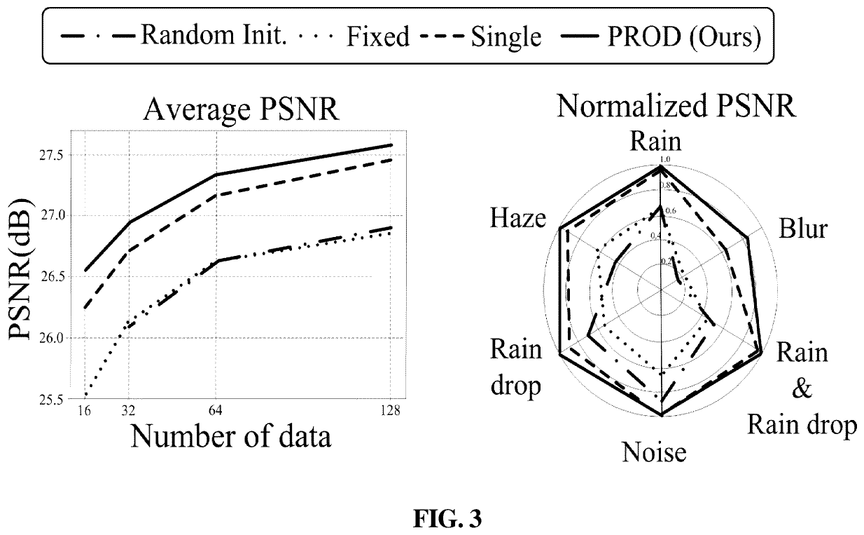

FIG. 3 is a diagram illustrating the performance of pre-training according to an embodiment. The evaluation of performance of pre-training may be performed while re-training the image restoration model for an image restoration task after the pre-training. As an example, for the re-training of the image restoration model for an image restoration task, six real image restoration task datasets, including Real Rain (RainDS), Raindrop (RainDS), Rain and Raindrop (RainDS), Noise (SIDD), Haze (SMOKE), and Blur (BSD), were used, and the image restoration model was implemented using CNN-based NAFNet.

More specifically, RainDS is composed of 120 pieces of training data and 100 pieces of test data for each task of Rain, Raindrop, and Rain and Raindrop, and SMOKE is composed of 120 training images and 12 test images. BSD is composed of 3,300 training data and 400 test images. SIDD may be composed of 160 training images and 1,280 pieces of validation data, and the validation data may be composed of 256×256 patch images.

Meanwhile, in FIG. 3, PROD is pre-training with random order degradation according to an embodiment, and refers to a method that generates low-quality training data by randomly applying various synthetic degradation functions to a clean image and performs pre-training using the generated training data. Random Init. refers to a method that randomly initializes network parameters without a pre-trained model. Furthermore, Single refers to a method that generates low-quality training data by randomly applying various synthetic degradation functions to a clean image once and performs pre-training using the generated training data. Fixed refers to a method that generates low-quality training data by applying various synthetic degradation functions to a clean image in a fixed order and performs pre-training using the generated training data.

The left image of FIG. 3 is a line graph in which the horizontal axis represents the number of training data during fine tuning and the vertical axis represents the average peak signal-to-noise ratio (PSNR) results of six image restoration tasks. The individual vertical lines represent the average PSNRs for four different amounts of training data, i.e., 16, 32, 64, and 128 pieces of training data, and a higher PSNR value means a higher restored image quality. Referring to the left image of FIG. 3, it can be seen that PROD according to an embodiment is superior to other pre-training methods (Random Init., Fixed, and Single). In particular, PROD according to an embodiment using 32 pieces of training data exhibited performance improvements of 0.05 dB and 0.10 dB compared to Random Init. and Fixed using 128 pieces of training data, respectively.

Meanwhile, the right image of FIG. 3 is a radar graph, which shows the normalized PSNR results when the number of test data for each of the six image restoration tasks is 128. Referring to the right image of FIG. 3, it can be seen that the performance thereof is superior to those of the other three pre-training methods.

According to the foregoing description, the image restoration apparatus 100 according to an embodiment obtains various low-quality training images by applying a plurality of synthetic degradation functions to a clean image one at a time, in which case the synthetic degradation functions to be applied are randomly determined. Accordingly, the diversity of training data may be increased, and thus, the training effect of the image restoration model for various degradations may be increased.

### Contribution-Based Low-Rank Adaptation (CoLoRA)

The controller 120 may perform fine tuning only on some network parameters, not all the network parameters, when training the pre-trained image restoration model for an actual image restoration task. In other words, the controller 120 may update only some network parameters according to the ratio of learnable network parameters without updating all the parameters of the network. The controller 120 may perform parameter updates only for some network parameters based on low-rank adaptation (LoRA) (see Low-Rank Adaptation, Hu et al. LoRA: Low-Rank Adaptation of large language models. arXiv: 2106.09685, 2021). The controller 120 may determine the ratio of parameters differently for each layer based on the contribution of each of the layers constituting the network.

Before describing a method of fine-tuning the image restoration model, the contribution for each layer and a method of computing the contribution for each layer will be described first.

The contribution refers to whether a target plays an important role in the obtainment of results when performing a specific image restoration task. In a method of training the image restoration model according to an embodiment, the computation of the filter attribution integrated gradients (FAIG) score (see Xie et al., Finding discriminative filters for specific degradations in blind super-resolution. NeurIPS, 2021), which is a discriminative filter for specific degradations, may be utilized. In this case, the FAIG score may be computed based on Equation 1 below:

$${FAIG}_{j} ( {θ}_{b a} , {θ}_{ta} , x ) \approx \vert {\frac{1}{M} [ {θ}_{b a} - {θ}_{ta} ]}_{j} {{\sum }_{t = 0}^{M - 1} [ \frac{\partial ℒ ( ρ ( {β}_{t} ) ) , x}{\partial ρ ( {β}_{t} )} ]}_{j} \vert \qquad ( 1 )$$

In Equation 1, x is an input image, θ_{ba} is a baseline model, θₜₐ is a target model, and M is the total steps of integral approximation, which is set to 100 in FAIG. βₜ is t/M, j is a kernel (filter) index, and ρ is the interpolation between the baseline model and the target model.

Based on Equation 1, the controller 120 may compute the FAIG score of each layer to determine the contribution for each layer of the image restoration model. For example, the controller 120 may use an image restoration model having undergone PROD as the baseline model θ_{ba} and also use an image restoration model having performed a single synthetic degradation operation based on the pre-trained image restoration model as the target model θₜₐ. In this case, the controller 120 may set j of Equation 1 as the layer index of the network and measure an FAIG score for each layer.

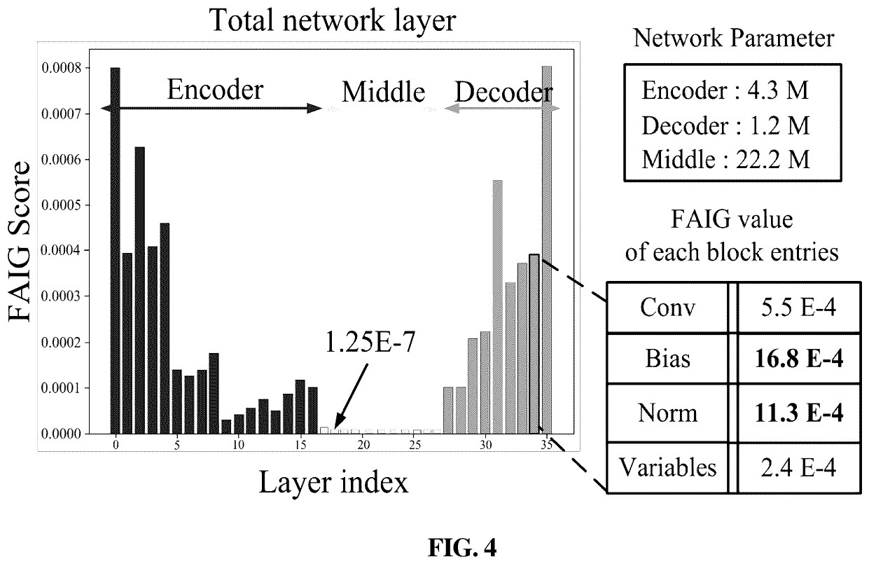

FIG. 4 is a diagram illustrating the contribution of each layer of an image restoration model according to an embodiment. More specifically, FIG. 4 illustrates FAIG scores for respective layers with respect to the total network layer.

The horizontal axis of FIG. 4 represents the layer index. For example, the index of a layer to which an image is input may be 0, and the index of a layer from which a restored image is output may be 35. The vertical axis represents the FAIG score, and the number of network parameters constituting the overall network is shown on the right side of FIG. 4.

An image restoration model according to an embodiment may be implemented as NAFNet. NAFNet may include an encoder, a decoder, and a middle layer between the encoder and the decoder. The encoder may include 4.3M parameters, and the decoder may include 1.2M parameters. The number of network parameters included in the encoder and the decoder accounts for about 18% of the total number of parameters. The middle layer may include 22.2M parameters, which accounts for 80% of the total number of parameters.

Referring to FIG. 4, it can be seen that the FAIG score of the layers included in the middle layer, which account for most of the total parameters, are 1.25 E−7, which is much smaller than the FAIG scores of the layers included in the encoder or decoder. This means that the contribution of the middle layer to the overall image restoration task is lower than that of the decoder or encoder. Accordingly, based on the results of FIG. 3, the controller 120 may tune the parameters included in the layers included in the encoder and the decoder, excluding the parameters of the layers included in the middle layer, during fine tuning.

Meanwhile, as described above, the image restoration model may be implemented as NAFNet, and each layer of NAFNet may include a convolution layer Conv, a normalization layer Norm, a bias layer Bias, and variables. Referring to the right table of FIG. 4, it can be seen that the FAIG scores of the bias and normalization layers are much higher than those of the convolution layer and the variables, which indicates that the contribution of the bias and normalization layers is higher. Accordingly, the controller 120 may also fine-tune the parameters included in the bias and normalization layers when fine-tuning the network parameters.

In an embodiment, the controller 120 computes FAIG scores for the image restoration model θₜₐ having performed a single synthetic degradation task, and determines the contribution for each network layer based on them. However, according to an embodiment, for different single image restoration tasks, FAIG scores for respective layers of the image restoration model may be computed for each of the image restoration tasks, and the contribution for each network layer may be determined by comprehensively considering FAIG scores for the different single image restoration tasks.

For example, for two image restoration tasks of Blur and Raindrop, FAIG scores for respective network layers may be computed for an image restoration task for Blur, FAIG scores for respective network layers may be computed for an image restoration task for Raindrop, and contributions may be determined based on the averages of the two types of FAIG scores computed.

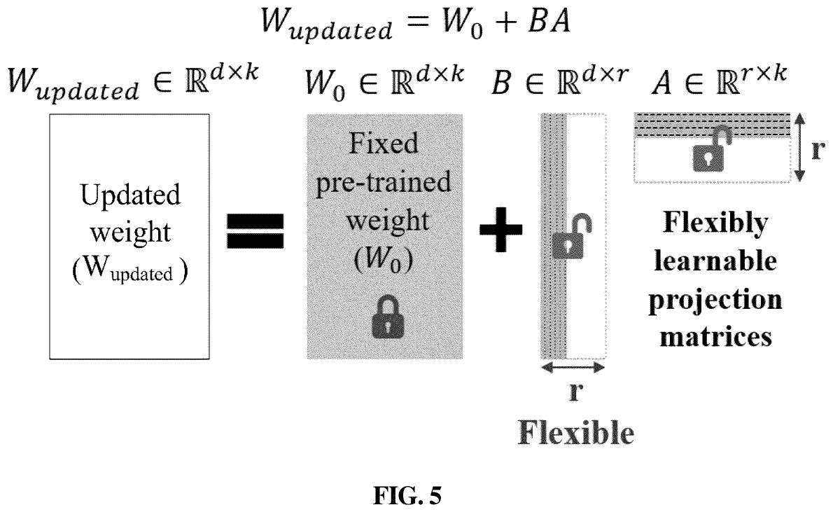

FIG. 5 is a diagram illustrating a method of fine-tuning network parameters according to a training method according to an embodiment.

As described above, the controller 120 may perform parameter update only for some learnable network parameters based on low-rank adaptation (LoRA). As shown in Equation 2, the low-rank adaptation (LoRA) method fixes all the weights of a pre-trained image restoration model and updates parameters included in flexibly learnable projection matrices.

$${W}_{updated} = {W}_{0} + B A \qquad ( 2 )$$

In Equation 2, W₀ is the weight matrix of the pre-trained model and satisfies W₀∈ [symbol] , and W_{updated} is a weight matrix in which changed weights have been reflected in the weights of the pre-trained model, and satisfies W_{updated}∈ [symbol] . In this case, [symbol] means a two-dimensional matrix of d×k on a ring [symbol] . d and k denotes the sizes of the matrices W₀ and W_{updated}. Furthermore, A and B are learnable projection matrices, and are A∈ [symbol] and B∈ [symbol] .

In this case, the size of the projection matrix is determined according to rank r. Unlike the fixed size of rank r used for all the layers in the conventional low-rank adaptation (LoRA), the size of rank r may be determined differently based on the contribution of each layer in the contribution-based low-rank adaptation (CoLoRA) according to an embodiment, as shown in FIG. 4.

In this case, the contribution for each layer may be determined by the FAIG score for each layer as described in FIG. 3 and Equation 2. As described above, the controller 120 may perform PROD, and may compute FAIG scores using an image restoration model having performed single degradation tasks as the target model.

Furthermore, according to the embodiment, the controller 120 may determine the contribution and the ratio of learnable network parameters for each layer by computing FAIG scores for each single degradation task for a plurality of different single degradation tasks and comprehensively taking into consideration computed FAIG scores for the different single degradation tasks.

Meanwhile, the ratio of learnable network parameters may be determined according to rank r, which determines the size of the learnable projection matrix of each layer, as shown in Equation 3 below:

$${δ}_{i} = ( {r}_{i} ( {d}_{i} + {k}_{i} ) ) / ( {d}_{i} + {k}_{i} ) \qquad ( 3 )$$

In Equation 3, i denotes a layer index, indicating that a target layer is the i-th layer of the overall network. Furthermore, δᵢ denotes the ratio of learnable network parameters of the i-th layer, dᵢ and kᵢ denote the size of the weight matrix W₀ of the pre-trained image restoration model of the i-th layer, and rᵢ denotes rank r of the i-th layer determined according to the contribution.

Meanwhile, as the ratio δ of fine-tunable parameters increases, the performance improves, but more network parameters are required. Accordingly, the value of rᵢ, which determines the size of a flexibly learnable projection matrix for each layer, and the value of the ratio δᵢ of learnable network parameters for each layer may be experimentally selected according to the contribution. For example, in the contribution-based low-rank adaptation according to an embodiment, the size of rᵢ may be designed such that approximately 7% of the parameters of the overall network are selected.

Meanwhile, as illustrated in FIG. 5, the contribution of the bias and normalization layers is high. Accordingly, the contribution-based low-rank adaptation according to an embodiment may update parameters for the bias and normalization layers in the same manner as it updates parameters for other layers, such as the convolution layer. In other words, the ratio of learnable network parameters for each layer may be determined for each of the bias and normalization layers, and parameters may be updated according to the low-rank adaptation shown in Equation 2. This is different from the operation of the conventional low-rank adaptation (LoRA) method that does not update the parameters of the bias and normalization layers.

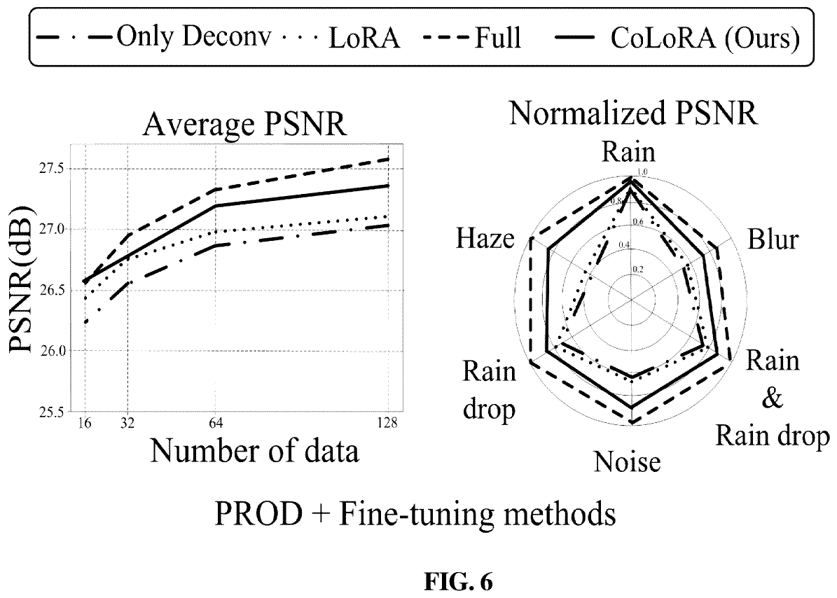

FIG. 6 is a diagram illustrating the performance of contribution-based low-rank adaptation according to an embodiment. For the evaluation of performance illustrated in FIG. 6, six real image restoration task datasets, including Real Rain (RainDS), Raindrop (RainDS), Rain and Raindrop (RainDS), Noise (SIDD), Haze (SMOKE), and Blur (BSD), were used, as in FIG. 3, the image restoration model was implemented using CNN-based NAFNet, and pre-training was performed using pre-training with random order degradation (PROD) according to an embodiment.

The left image of FIG. 6 is a line graph in which the horizontal axis represents the number of training data during fine tuning and the vertical axis represents the average PSNR results of the six image restoration tasks, like the left image of FIG. 3. The individual vertical lines represent the average PSNRs for four different amounts of training data, i.e., 16, 32, 64, and 128 pieces of training data, and a higher PSNR value means a higher restored image quality.

Meanwhile, in FIG. 6, CoLoRA denotes contribution-based low-rank adaptation according to an embodiment, and Full denotes a method of fine-tuning all parameters. Furthermore, Only Deconv denotes a method of tuning only the parameters included in a decoder, and LoRA denotes a method of tuning parameters using the conventional low-rank adaptation. Table 1 below shows the numbers of parameters tuned by the respective methods described above.

Referring to Table 1, the method of tuning all network parameters (Full) tunes 20 million (20M) parameters, whereas the contribution-based low-rank adaptation (CoLoRA) according to an embodiment, the conventional low-rank adaptation (LoRA), and the method of tuning only the parameters included in a decoder (Only Deconv) tunes about 2 million parameters.

TABLE 1

| Method | Tuned parmeter (M) |
|---|---|
| Only Deconv | 1.942 |
| LoRA | 2.442 |
| CoLoRA (Ours) | 2.063 |
| Full | 29.160 |

However, referring to FIG. 6, the contribution-based low-rank adaptation (CoLoRA) according to an embodiment that tuned a similar number of parameters exhibited higher performance than the conventional low-rank adaptation (LoRA) and the method of tuning only the parameters included in a decoder (Only Deconv). In particular, the contribution-based low-rank adaptation (CoLoRA) according to an embodiment that used 64 pieces of training data exhibited 0.15 dB and 0.08 dB better performance than the conventional low-rank adaptation (LoRA) using 128 pieces of training data and the method of tuning only the parameters included in a decoder (Only Deconv), respectively.

According to the foregoing description, the contribution-based low-rank adaptation (CoLoRA) according to an embodiment may achieve desirable performance despite the tuning of a number of parameters considerably smaller than the total number of parameters. Accordingly, the memory and processing time required for fine-tuning the parameters may be reduced.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

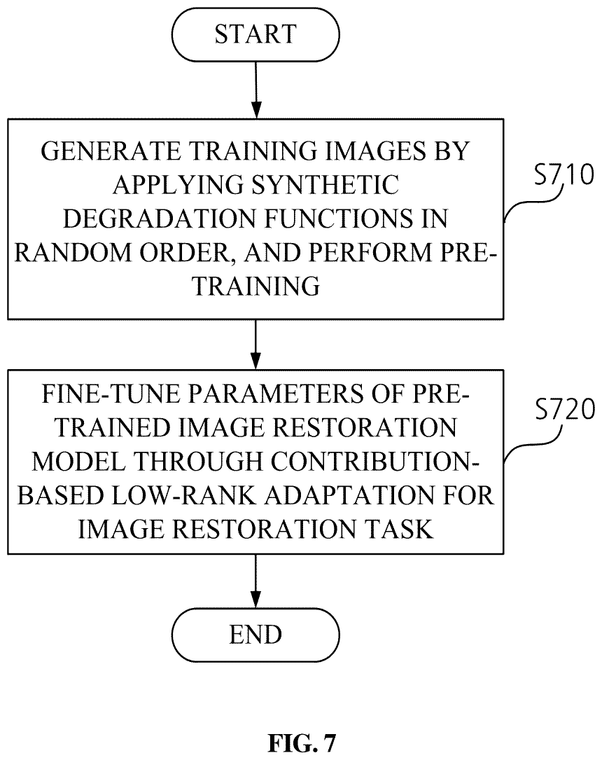

FIG. 7 is a flowchart illustrating a method of training an image restoration model according to an embodiment. The training method of FIG. 7 includes the steps that are processed in a time-series manner by the image restoration apparatus 100 shown in FIGS. 1 to 6. Accordingly, the descriptions that are omitted below but have been given above in conjunction with the image restoration apparatus 100 shown in FIGS. 1 to 6 may also be applied to the training method according to the embodiment shown in FIG. 7.

Referring to FIG. 7, the image restoration apparatus 100 generates training images by applying a plurality of synthetic degradation functions to a clean image in a random order and pre-trains the image restoration model in step S710.

More specifically, the image restoration apparatus 100 sequentially applies at least some of the plurality of different synthetic degradation functions to the clean image one by one, in which case the order of application may be randomly determined.

Accordingly, obtaining training images by applying the plurality of synthetic degradation functions one by one in a random order may obtain a larger number of different types of training images than obtaining training images by applying a plurality of synthetic degradation functions in a fixed order or applying only one synthetic degradation function. Accordingly, a massive number of training images required for pre-training may be obtained, and pre-training may be performed for various degradations.

Next, the image restoration apparatus 100 may fine-tune the parameters of the pre-trained image restoration model for an image restoration task in step S720. In this case, the image restoration apparatus 100 may fine-tune the parameters of each layer of the image restoration model based on low-rank adaptation, and may determine the ratio of learnable network parameters based on the contribution of each layer of the pre-trained image restoration model.

More specifically, the image restoration apparatus 100 may perform training for an arbitrary image restoration task of the pre-trained image restoration model. For example, the image restoration apparatus 100 may perform training for an image restoration task for Blur or Raindrop based on a dataset including image degradation attributable to blur or raindrops. When performing an image restoration task, the image restoration apparatus 100 may compute an FAIG score for each layer of the image restoration model based on Equation 1, and may determine the contribution of each layer based on the computed FAIG score.

Next, rᵢ that determines the size of the projection matrix of each layer and the ratio δᵢ of learnable network parameters of each layer according to Equation 3 may be determined based on the contribution of each layer. The image restoration apparatus 100 may fine-tune the parameters of the image restoration model through the low-rank adaptation shown in Equation 2 according to the determined rᵢ and ratio δᵢ of learnable network parameters. As an example, rᵢ and δᵢ may be determined by experiment.

In this case, unlike the conventional low-order adaptation (LoRA), the image restoration apparatus 100 may perform parameter update through contribution-based low-order adaptation for the bias and normalization layers. In other words, the ratio of learnable network parameters is determined according to the contribution for each of the bias and normalization layers, and the image restoration apparatus 100 may update the parameters included in the bias and normalization layers by using the learnable projection matrix according to Equation 2.

According to the foregoing description, in the method of training the image restoration model according to an embodiment, the image restoration apparatus 100 according to an embodiment applies a plurality of synthetic degradation functions to a clean image one at a time, in which case the synthetic degradation functions to be applied are randomly determined, thereby obtaining various low-quality training images. Accordingly, the diversity of training data may be increased, and thus, the training effect of the image restoration model for various degradations may be increased. In addition, the method of training the image restoration model according to an embodiment may achieve desirable performance despite the tuning of a considerably small number of parameters compared to the total parameters, so that the memory and processing time required for fine-tuning the parameters may be reduced.

The training method according to the embodiment described in conjunction with FIG. 7 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the training method according to the embodiment described in conjunction with FIG. 7 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the training method according to the embodiment described in conjunction with FIG. 7 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A method of training an image restoration model, the method being performed by an image restoration apparatus, the method comprising:
pre-training an image restoration model by generating training images by randomly applying a plurality of synthetic degradation functions to a clean image; and
fine-tuning parameters of the pre-trained image restoration model through contribution-based low-rank adaptation for an image restoration task;
wherein fine-tuning the parameters comprises fine-tuning parameters of each layer of the image restoration model based on a ratio of learnable network parameters, determined according to a contribution of each layer of the pre-trained image restoration model, and low-rank adaptation for the image restoration task.

2. The method of claim 1, wherein pre-training the image restoration model comprises randomly selecting the plurality of synthetic degradation functions from among a plurality of different synthetic degradation functions, and sequentially applying the plurality of synthetic degradation functions to the clean image one by one in a randomly determined order.

3. The method of claim 1, wherein fine-tuning the parameters comprises also fine-tuning parameters of bias layers and normalization layers included in the pre-trained image restoration model.

4. The method of claim 1, wherein fine-tuning the parameters comprises computing a FAIG score for each layer during re-training of the pre-trained image restoration model for the image restoration task, in order to determine the contribution of each layer.

5. An image restoration apparatus, comprising:
memory configured to store an image restoration model and a program required for training the image restoration model; and
a controller including at least one processor, and configured to train the image restoration model;
wherein the controller pre-trains the image restoration model by generating training images by randomly applying a plurality of synthetic degradation functions to a clean image, and fine-tunes parameters of the pre-trained image restoration model for an image restoration task, in which case parameters of each layer of the image restoration model are fine-tuned based on low-rank adaptation according to a contribution for each layer of the pre-trained image restoration model for the image restoration task.

6. The image restoration apparatus of claim 5, wherein the controller randomly selects the plurality of synthetic degradation functions from among a plurality of different synthetic degradation functions, and sequentially applies the plurality of synthetic degradation functions to the clean image one by one in a randomly determined order.

7. The image restoration apparatus of claim 5, wherein the controller also fine-tunes parameters of bias layers and normalization layers included in the pre-trained image restoration model.

8. The image restoration apparatus of claim 5, wherein the controller computes a FAIG score for each layer during re-training of the pre-trained image restoration model for the image restoration task, in order to determine the contribution of each layer.

9. A computer program that is executed by an image restoration apparatus and stored in a non-transitory computer-readable storage medium to perform the method set forth in claim 1.

10. A non-transitory computer-readable storage medium having stored thereon a program that, when executed by a processor, causes the processor to execute the method set forth in claim 1.
